(19) United States
(12) Patent Application Publication
(10) Pub. No.: US 2025/0067403 A1
(43) Pub. Date: Feb. 27, 2025

(54) EDUCTED FLAME SUPPRESSOR

(71) Applicant: TDW Delaware, Inc., Wilmington, DE (US)

(72) Inventor: Roger L. Poe, Beggs, OK (US)

(21) Appl. No.: 18/813,731

(22) Filed: Aug. 23, 2024

Related U.S. Application Data
(60) Provisional application No. 63/578,209, filed on Aug. 23, 2023.

(51) Int. Cl. F17D 5/00; A62C 3/06

(52) U.S. Cl. CPC F17D 5/005; A62C 3/06

(57) ABSTRACT

A flame suppressor for venting pipelines, vessels or tanks containing a combustible gas includes a quench module and an injector located in a flow path of the vented pipeline product exiting the quench module. The injector introduces an educted jet of a second gas into the flow path so that vented pipeline product has speed above a flame propagation speed of the combustible gas. The second gas may be a non-combustible or inert gas or air and may be used to dilute, as well as accelerate, the vented pipeline product. Or the second gas may inject a combustible gas, for example, methane, still accelerating the vented pipeline product.

### CROSS-REFERENCE TO CO-PENDING APPLICATIONS

This application claims priority to, and benefit of, U.S. Application No. 63/578,209,filed Aug. 23, 2023.

### FIELD OF THE DISCLOSURE

This disclosure relates to pipeline hot tapping and plugging in general and, more specifically, flame suppression safety during the removal of high-pressure gasses from isolated pipeline sections during hot tapping operations.

### BACKGROUND

Hot tapping is a method of connecting to an in-service pipeline or vessel while under pressure, allowing for the diversion or extraction of fluid with minimum interruption of product flow through the system. In hot tapping operations, some systems, such as T.D. Williamson's STOPPLE® system, sections of pipeline are isolated with plugging means, and pipeline product in the isolated sections must be removed before pipeline sections can be replaced or repaired.

Removal of pipeline gases must be properly done because the gases can present potential risks for pipeline workers and others nearby as well as the pipeline. In pipelines, combustible gases move in large volumes of gas. For example, a typical 24-inch methane pipeline at 1800 psig (pounds per square inch gauge) carries up to 600,000 SCFM (standard cubic feet per minute). Heavier gases, if not properly mixed or dispersed, can explode or cause an asphyxiation risk. Lighter gases, like hydrogen, tend to mix quickly with air, creating a highly volatile mixture. Hydrogen has become more common in pipelines because of its environmental advantages over other combustible gases, but its greater volatility can present increased potential risk for the pipeline, pipeline workers, and others nearby.

To remove all the product from an isolated section of pipeline, the product is initially vented into the air. Afterward, a vacuum is applied to draw the remaining product out but any ambient volume remaining in the pipe can remain a risk for fire or explosion. Vented gas can be mixed with nitrogen or another dilutant to lower the likelihood of explosion and minimize the risk of heavier gases remaining concentrated. However, existing systems cannot completely eliminate all of the risk as the gas is re-injected or vented to atmosphere.

Combustion explosions occur when the actual admixture velocity is less than the flame propagation speed for a given gas. In all vented conditions, as the pressure lowers or decays within the pipeline, tank or vessel, the flame propagation velocity will eventually exceed the normal expansion velocity of the vented pipeline gas. Unless the gas is accelerated, even a small flamelet can explode a significant quantity of product. This explosion can damage infrastructure both internal and external to the pipeline.

What is needed is a device, system, and method that further decreases the likelihood of an explosion or flare-up by diluting venting combustible pipeline gases and by increasing the velocity of vented combustible pipeline gases, especially beyond their flame propagation velocities, making it impossible for the venting product to flashback into the pipeline before it is rendered nonexplosive.

### SUMMARY

Embodiments of this disclosure comprise a fire or flame suppressor for venting pipelines. The flame suppressor has a quench module with a plurality of ports and an injector oriented toward an exhaust end of the flame suppressor. The ports, which may be cylindrical, are configured or arranged such that vented pipeline product has a higher velocity through the quench module than through a pipeline tap. In embodiments, the ports provide a flow path having a cross-sectional area equal to that of a cross-sectional area of the pipeline tap. The injector is configured or arranged so that vented product has a higher velocity between the injector and the exhaust end than through the quench module. The injector, which may be an eductor (e.g., a jet pump or venturi pump), injects a non-combustible or inert gas or air—or a gas, like methane, under pressure—into the flame suppressor, thereby producing an eductor jet. In embodiments, the educted fluid is supplied from a different source than that of the vented product. The injector is spaced a pre-determined distance from the quench module. In some embodiments the injector is 12, 8, or 4 inches of the quench module.

In another aspect, embodiments include a system for venting product from a pipeline. The system comprises a pipeline tap, a pipeline venting mechanism, a valve such as but not limited to a gate valve, and the flame suppressor. The flame suppressor is adapted for use in connection with a pipeline containing gas, the flame suppressor including a first tube having a first diameter and an inlet end; a second tube having a second diameter less than the first diameter and an outlet end; a quench element located between the first and second tubes, the quench element having a third diameter and comprising a plate containing a plurality of longitudinally extending cylindrical ports therethrough, and an injector having a nozzle located in an interior volume of the second tube, the nozzle oriented toward the outlet end. A weld neck flange is coaxial with the quench module.

Embodiments of a method for venting pipeline product from an isolated section of pipeline include the steps of installing a pipeline tap and a venting pipe mechanism; attaching a flame suppressor of this disclosure to the venting pipe mechanism; and venting the pipeline product. When venting the pipeline product, the product moves, first, through the pipeline tap; second, through the venting pipe mechanism where it accelerates; third, through the quench module of the flame suppressor; fourth, past the injector of the flame suppressor; and, finally, through the exhaust end of the flame suppressor. The vented pipeline product has a higher velocity through the quench module than through the pipeline tap. The vented pipeline product has a higher velocity between the injector and the exhaust end of the flame suppressor than through the quench module. The intent is to accelerate the gas significantly higher than the flame propagation speed for the gas.

### BRIEF DESCRIPTION OF THE DRAWINGS

FIG. 1 is an isometric view of an embodiment of an educted flame suppressor.

FIG. 2 is sectional view of the educted flame suppressor of FIG. 1.

FIG. 3 is an end view of the educted flame suppressor of FIG. 1.

FIG. 4 is a plot showing the sonic velocity for most gases at approximately 1,160 feet per second (˜353.6 mps) discharged at ambient conditions. As the pressure of the bulk gas lowers, the gas will eventually begin to lower in velocity to a point that it will lower in overall velocity as well and the velocity drops below the flame propagation velocity and potentially igniting. Embodiments of this disclosure create a differential pressure to keep the velocity elevated, accelerating the gas to a velocity significantly higher than would be the case in normal expansion. This velocity, coupled with a quench module, keeps the gas moving at a velocity above which it can ignite.

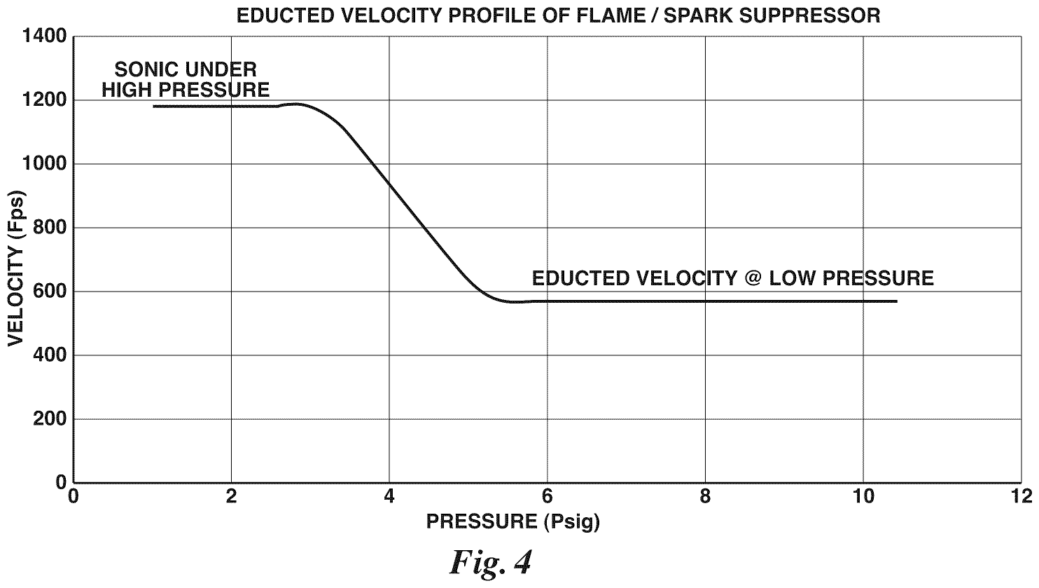

### ELEMENTS USED IN THE DRAWINGS AND DETAILED DESCRIPTION

10 flame suppressor
12 weld neck flange
14 quench module
15 inlet end
16 injector/eductor
17 outlet end
18 inlet-side pipe or tube
20 intake end
28 outlet-side pipe tube
30 exhaust end
42 plurality of ports
62 eductor jet or educted jet
100 pipeline tap
110 venting pipe mechanism

### DETAILED DESCRIPTION

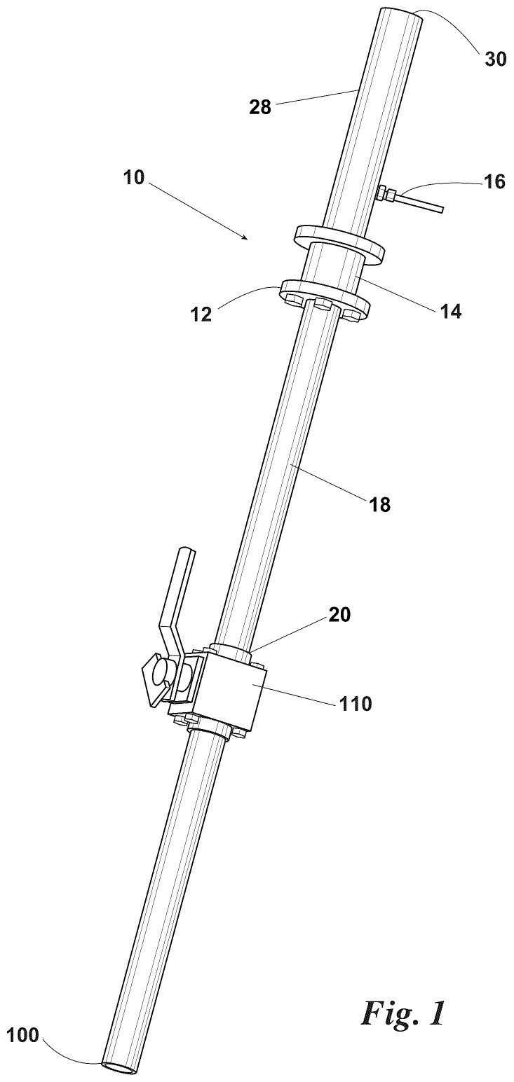

Referring to FIG. 1, an educted flame suppressor 10 of this disclosure is shown mounted to a venting pipe mechanism 110, for example, a valve, such as a gate valve. The venting pipe mechanism 110 may be connected to a first source of pipeline product, such as pipelines, vessels or tanks. The pipeline product includes a flammable or combustible gas and is typically under pressure. The flame suppressor 10 has an intake end 20 and an exhaust end 30. Pipeline product being vented enters the flame arrester 10 from a pipeline tap 100 through the venting pipe mechanism 110. At the intake end 20 of the flame suppressor 10, the product passes through a weld neck flange 12, into a quench module 14, past an injector 16, and toward the exhaust end 30.

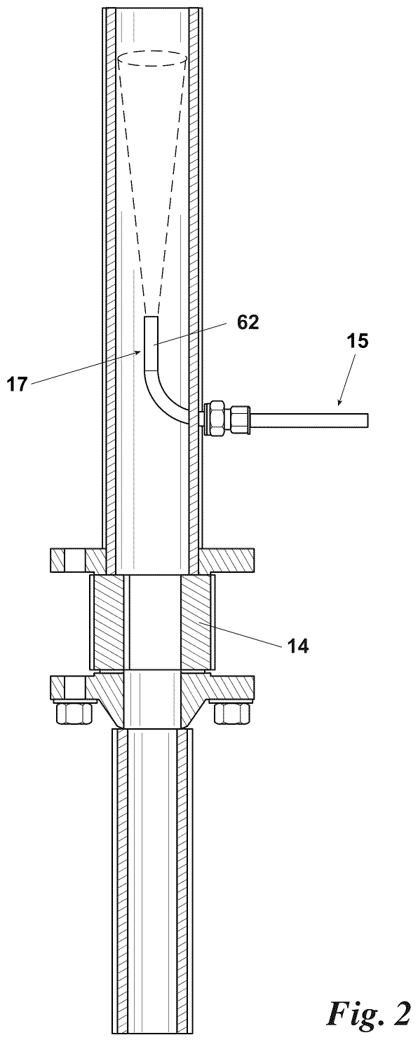

Referring now to FIG. 2, a sectional view of an educted flame arrester 10 is shown. The injector 16 is directed toward the exhaust end 30 to accelerate venting pipeline product, disperse and dilute venting product, and increase the pressure differential between the pipeline tap 100 and the atmosphere (not shown). A non-combustible gas—such as nitrogen or carbon dioxide or the like—or an inert gas, such as argon or helium or the like—may be injected through the injector 16, forming the eductor jet 62.

The injector 16 may also inject a combustible gas such as methane or the like. The resulting jet 62 still pulls a vacuum but also ejects the gas or mixture from the exhaust end 30 above the flammability limit, rendering the ejected gas stream harmless to the pipeline in the near stream.

In embodiments, the injector 16 includes an inlet end 15 adapted for connection to a source of fluid for use as the educted jet 62 and an outlet end 17 located within an interior space 29 of the suppressor 10 and oriented toward the exhaust end 30. The injector 16 may be located near, but downstream of, the quench module 14, such as within 4, 8, or 12 inches (˜10, 20, 30 cm).

In embodiments, the velocity of pipeline product between the injector 16 and the exhaust end 30 of the educted flame suppressor 10 is greater than the velocity of pipeline product through the quench module 14 and greater than the velocity of the pipeline product through the pipeline tap 100. In embodiments, the velocity of pipeline product between the injector 16 and the exhaust end 30 is greater than the product's normal expansion velocity and greater than the product's flame propagation velocity. The higher the velocity of the gas, the lower the risk or propensity for ignition.

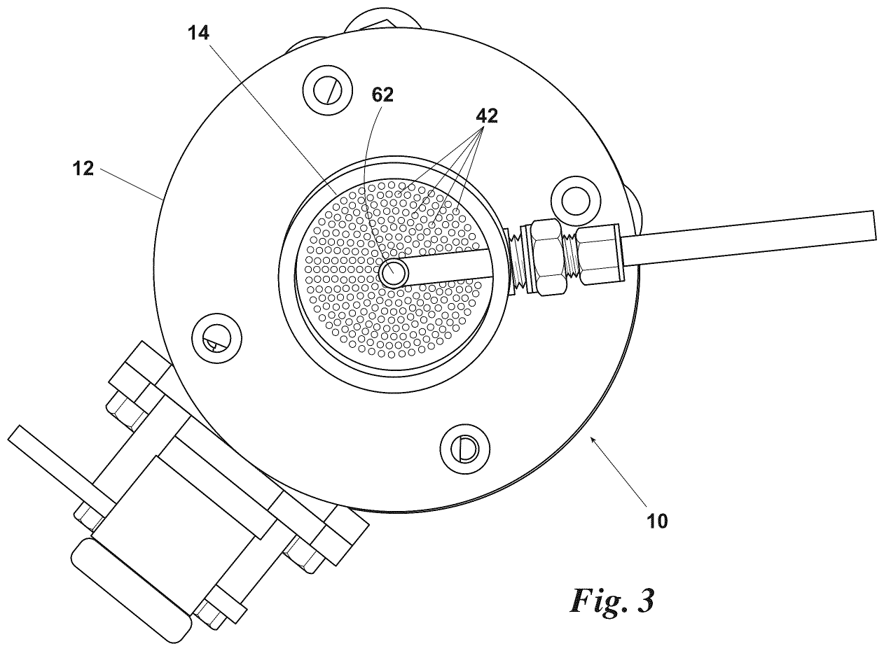

Referring now to FIG. 3, an end view of the educted flame arrester 10 is shown. The quench module 14 comprises a plurality of ports 42 through which vented product passes on its way from the pipeline tap 100 to the exhaust end 30 of the flame arrester 10. In embodiments, each of the plurality of ports 42 may be cylindrical, running the length of the quench module 14. The quench module 14 may be constructed from a material that is thermally conductive and easily machined, such as aluminum or brass. The flow path through the quench module 14 may have a cross sectional area equal to that of the cross sectional area of the pipeline tap 100. If a quiescent eddy would happen to exist somewhere toward the inlet 20 of the arrestor 10, the quench module 14 functions as a secondary system to suppress any flame attempting to propagate forward into the pipeline system.

In embodiments of this disclosure, the quench module 14 can be located between an inlet-side tube or pipe 18 and a outlet-side tube or pipe 28. The outlet-side pipe 28 may have a larger diameter than that of the inlet-side pipe 18. The injector 16 is located along the outlet side pipe and arranged so it provides an educted jet 62 of fluid within an interior space 29 of the pipe 28, the educted jet 62 directed toward the exhaust end 30. The injector 16 is in fluid communication with a source of fluid different than the source of the vented pipeline product. The source of fluid may supply a flammable or combustible fluid or an inert fluid. The combustible fluid may be the same as that of the vented pipeline product.

When in use, the combustible first gas is instroduced upstream of the educted jet 62, the educted jet 62 comprises a second gas being introduced into the outlet pipe 28, and the fluid above the educted jet 62 is an admixture of the first and second gases. The actual admixture velocity is above the flame propagation speed for the combustible first gas.

In embodiments, the velocity of venting pipeline product through the quench module 14 is greater than the velocity of the pipeline product through the pipeline tap 100. In embodiments, the velocity of pipeline product through the quench module 14 is greater than the product's normal expansion velocity and greater than the product's flame propagation velocity. The higher the velocity through the quench module 14, the higher the heat transfer coefficient. As the heat is transferred convectively from any flame attempting to stabilize within the module, the energy required to sustain the flame is lost, thereby rendering the flame foothold or anchor non-viable. The flame is then extinguished.

In embodiments, the quench module 14 and the injector 16 are configured or arranged so that the vented pipeline product travels through the quench module 14, past the injector 16, and to the exhaust end 30 at a velocity higher than the product's normal expansion velocity and higher than the product's flame propagation velocity, rendering an explosion unlikely or even impossible. The injector 16 provides a jet 62 that increases the velocity of the product being vented.

In embodiments of a method of this disclosure for reducing a flammability risk of a vented pipeline product including a combustible first gas, the method comprises venting the combustible first gas through a flame suppressor 10 including a quench module 14 and, downstream of the quench module 14, educting a second gas into the flow of the combustible first gas so as to accelerate a speed of the combustible gas; wherein, after the educting, the speed of the combustible first gas is above a flame propagation speed of the combustible first gas.

In another embodiment of a method of this disclosure for reducing a flammability risk of a combustible first gas when vented from a section of pipeline, the method comprises installing an injector 16 within an outlet pipe 28 in communication with a venting mechanism 110 of the section of pipeline, the injector 16 arranged to educt a second gas into a flow path of the combustible first gas and toward an exhaust end 30 of the outlet pipe 28. The installing may be a retrofitting of an existing vent system of a pipeline.

A flame needs three things to exist: time, temperature, and an oxidizer. Reducing the duration of time a gas resides within a heat zone and exposed to an oxidizer reduces the risk of fire or explosion: the gas cannot gain enough heat to ignite. Embodiments of this disclosure can be used to evacuate pipelines, vessels and tanks, and can be engineered and applied to reduce flammability risk in specific applications. For example, when the line is tapped and the line is blown down, the pressure drops to zero because the line is dead and the velocity of the gas will drop to zero eventually. If air is introduced, the velocity of the gas is kept higher and the gas is voided completely. In some cases, embodiments of this disclosure may use the gas as a motive force to void the gas in the line. As long as the gas mixture is above the flammability limit, the chance of combustion is low.

Thus, embodiments of this disclosure are well adapted to carry out the objects and attain the ends and advantages mentioned above as well as those inherent therein. While the inventive device has been described and illustrated herein by reference to certain embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A flame suppressor adapted for connection to a venting mechanism of a source containing a pipeline product comprising a combustible first gas, the flame suppressor comprising:
an outlet-side pipe (28) arranged to receive the combustible first gas and including an injector (16) adapted to receive a second gas and oriented to educt the second gas into an interior space (29) of the outlet-side pipe and toward an exhaust end (30) of the outlet-side pipe;
wherein the source containing the pipeline product is selected from the group consisting of a pipeline, a vessel, and a tank.

2. The flame suppressor of claim 1, further comprising a quench module (14) connected to the outlet-side pipe (28) and located upstream of the injector to receive the combustible first gas prior to the outlet-side pipe.

3. The flame suppressor of claim 1, wherein the second gas is a gas selected from the group consisting of a non-combustible gas, an inert gas, and a combustible gas.

4. The flame suppressor of claim 1, wherein the source containing the second gas is different from the source containing the pipeline product.

5. A flame suppressor adapted for connection to a venting mechanism of a source containing pipeline product comprising a combustible first gas, the flame suppressor comprising:
an inlet end (20) and an exhaust end (30)
a quench module (14) located between the inlet and outlet ends and comprising a plurality of ports (42), each port providing a flow path for the combustible first gas; and
an injector (16) located between the quench module and the exhaust end, the injector having an inlet end (15) adapted for connection to a source of a second gas and having an outlet end (17) oriented toward the exhaust end of the flame suppressor and adapted to educt the second gas into an interior space (29) of the flame suppressor;
wherein the source containing the combustible first gas is selected from the group consisting of a pipeline, a vessel, and a tank.

6. The flame suppressor of claim 5, wherein the injector is located nearer to the quench module than to the exhaust end.

7. The flame suppressor of claim 5, wherein the second gas is a gas selected from the group consisting of a non-combustible gas, an inert gas, and a combustible gas.

8. A system for venting a combustible first gas from a source containing a pipeline product, the system comprising:
a tap (100) in communication with an interior space of the source;
a venting mechanism (110) connected to the tap; and
a flame suppressor (10) connected to the venting mechanism and comprising:
an inlet end (20) and an exhaust end (30);
a quench module (14) located between the inlet and outlet ends and including a flow path adapted to increase a speed of the combustible first gas; and
an injector (16) located downstream of the quench module, the injector having an inlet end (15) adapted for connection to another source, different than that of the first source, of a second gas and having an outlet end (17) oriented toward the exhaust end of the flame suppressor and adapted to educt the second gas into an interior space (29) of the flame suppressor;
wherein the source containing the pipeline product is selected from the group consisting of a pipeline, a vessel, and a tank.

9. The system of claim 8, wherein the quench module (14) comprises a plurality of ports plurality of ports (42) each providing the flow path for the combustible first gas.

10. The system of claim 8, wherein the injector is located nearer to the quench module than to the exhaust end.

11. The system of claim 8, wherein the pipeline venting mechanism is a valve.

12. The system of claim 8, wherein the flow path of the quench module has a cross-sectional area equal to a cross-sectional area of the tap.

13. The system of claim 8, wherein the second gas is selected from the group consisting of a non-combustible gas, an inert gas, and a combustible gas.

14. A method for reducing a flammability risk of a vented pipeline product including a combustible first gas, the method comprising:
venting the combustible first gas through a flame suppressor including a quench module; and
downstream of the quench module, educting a second gas into the flow of the combustible first gas so as to increase a speed of the combustible first gas above a flame propagation speed of the combustible first gas.

15. The method of claim 14, wherein the second gas is at least one gas selected from the group consisting of a non-combustible gas, an inert gas, and a combustible gas.

16. The method of claim 14, wherein the combustible first gas includes hydrogen.

17. A method for reducing a flammability risk of a combustible first gas when vented from a source containing a pipeline product, the method comprising:
installing an injector (16) within an outlet pipe (28) connected to a venting mechanism (110) of the section of pipeline, the injector arranged to educt a second gas into a flow path of the combustible first gas and toward an exhaust end (30) of the outlet pipe; wherein the source containing the pipeline product is selected from the group consisting of a pipeline, a vessel, and a tank.

18. The method of claim 17, wherein a source of the second gas is different than that of the combustible first gas, the second gas being a gas selected from the group consisting of a non-combustible gas, an inert gas, and a combustible gas.

19. The method of claim 17, wherein the combustible first gas includes hydrogen.

20. The method of claim 17, wherein the pipeline is an isolated section of pipeline.
